(19) United States
(12) Patent Application Publication
(10) Pub. No.: US 2011/0072238 A1
(43) Pub. Date: Mar. 24, 2011

(54) Method for variable length opcode mapping in a VLIW processor

(76) Inventor: Tibet Mimar, Morgan Hill, CA (US)

(21) Appl. No.: 12/586,354

(22) Filed: Sep. 20, 2009

(51) Int. Cl. G06F 15/76; G06F 9/06

(52) U.S. Cl. 712/22; 712/41; 712/E09.003

(57) ABSTRACT

The present invention provides a method for reducing program memory size required for a dual-issue processor with a scalar processor plus a SIMD vector processor. Coding the map of next group of instruction pairs in a no-operation (NOP) instruction of scalar and vector processor reduces the cases where one of the scalar or vector opcode being a NOP opcode. NOP for either scalar or vector processor defines the next 13 instructions as scalar-plus-vector, scalar-followed-by-scalar, or vector-followed-by-vector so that execution unit performs accordingly until next NOP or a branch instruction.

### BACKGROUND OF THE INVENTION

1. Field of the Invention

The invention relates generally to the field of processor chips and specifically to the field of single-instruction multiple-data (SIMD) processors. More particularly, the present invention relates to conditional and nested vector operations in a SIMD processor.

2. Description of the Background Art

Dual-issue processors execute two instructions at the same time. In some systems the execution units and instructions are identical, and either or both instruction could be executed depending on the processing requirements. TI's 8-wide VLIW processor have 8 execution units, and could issue 1 to eight instructions for each cycle [Simar, U.S. Pat. No. 6,182,203]. The execution units are not identical in this case. To signal grouping of instruction to be executed together, the following format is used:
Instruction 1 ∥
Instruction 2 ∥
Instruction 3
Instruction 4 ∥
Instruction 5
   In this case, instructions 1-3 are executed together, then instructions 4 and 5 are executed together. Simar uses a 256-wide opcode consisting of 8 32-bit opcodes, where 1 to 8 instructions could be executed in one group. This is coded using a P-bit in bit #0 of each opcode of these 32-bit opcodes. Scanning left to right all instructions until and including P=0 are grouped together within the boundary of 8 instructions. The disadvantage of this is that it requires one more bit to code grouping of instructions per opcode, or 8-bits total for 256-wide total combined opcode. In this case, all instructions could run on each of the execution unit, but with some restrictions, for example, certain execution units do not support multiply operation.
   Considering the case of a dual-issue processor with one RISC processor and one SIMD processor, we have two 32-bit opcodes that could execute in each cycle. In this case, since the instruction type of RISC and SIMD are quite different, we have to identify each one for proper operation. If we always execute one RISC and one SIMD, we would fill unused ones with NOP (no operation) or VNOP (vector NOP). However, this means quite of portion of program memory is wasted by containing NOP or VNOP because typically the ratio of one used to both used is probably about 50 percent. Adding another bit to signal grouping of instruction would not be feasible because there is usually no space for P-bit within the 32-bit opcode space of either RISC or SIMD. Adding two more bits to each opcode would increase the program memory width to a non-standard 66 bits from 64 bits.

### SUMMARY OF THE INVENTION

The present invention provides a method for coding dual-issue opcode fields where first, second, of both opcodes may be active. By coding the map the next 13 instruction pairs in a no-operation instruction provides for supporting of dual-issue and two-instructions sequential execution options. If one opcode is for a scalar processor, and second one is for a SIMD processor, then options of scalar-plus-SIMD, scalar-followed-by-scalar, and SIMD-followed-by-SIMD options are supported in both scalar opcode NOP and SIMD opcode VNOP indicating the map of next 13 instruction pairs. The method of present invention reduces the waste of program memory by compacting opcodes together instead of storing NOP or VNOP instructions, which equals to about 50 percent savings in program memory, or 50 percent reduction in program memory that is required.

### BRIEF DESCRIPTION OF DRAWINGS

The accompanying drawings, which are incorporated and form a part of this specification, illustrate prior art and embodiments of the invention, and together with the description, serve to explain the principles of the invention.

FIG. 1 shows detailed block diagram of the SIMD processor.

FIG. 2 shows details of the select logic and mapping of source vector elements.

FIG. 3 shows the details of enable logic and the use of vector-condition-flag register.

FIG. 4 shows different supported SIMD instruction formats.

FIG. 5 shows block diagram of dual-issue processor consisting of a RISC processor and SIMD processor.

FIG. 6 illustrates executing dual-instructions for RISC and SIMD processors.

FIG. 7 shows the programming model of combined RISC and SIMD processors.

FIG. 8 shows an example of vector load and store instructions that are executed as part of scalar processor.

FIG. 9 shows an example of vector arithmetic instructions.

FIG. 10 shows an example of vector-accumulate instructions.

FIG. 11 shows possible pairing of SIMD and vector unit opcodes.

FIG. 12 shows how NOP and VNOP instructions define opcode pairing for the following instructions.

FIG. 13 shows opcode grouping format codes for combinations of vector and scalar opcodes.

FIG. 14 shows format fields of NOP and VNOP instructions.

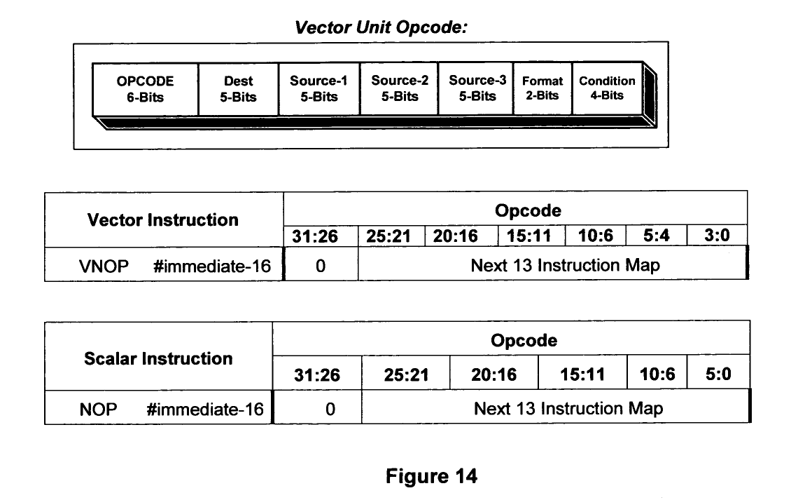

FIG. 15 shows an example case of code compression by eliminating most NOP and VNOPs.

### DETAILED DESCRIPTION

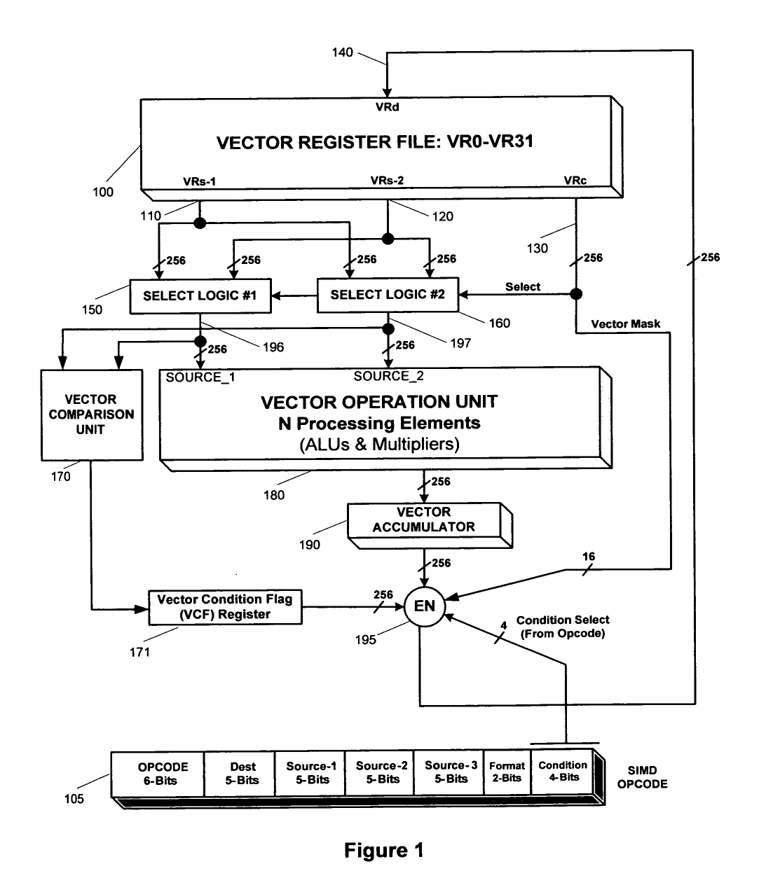

The SIMD unit consists of a vector register file 100 and a vector operation unit 180, as shown in FIG. 1. The vector operation unit 180 is comprised of plurality of processing elements, where each processing element is comprised of ALU and multiplier. Each processing element has a respective 48-bit wide accumulator register for holding the exact results of multiply, accumulate, and multiply-accumulate operations. These plurality of accumulators for each processing element form a vector accumulator 190. The SIMD unit uses a load-store model, i.e., all vector operations uses operands sourced from vector registers, and the results of these operations are stored back to the register file. For example, the instruction “VMUL VR4, VR0, VR31” multiplies sixteen pairs of corresponding elements from vector registers VR0 and VR31, and stores the results into vector register VR4. The results of the multiplication for each element results in a 32-bit result, which is stored into the accumulator for that element position. Then this 32-bit result for element is clamped and mapped to 16-bits before storing into elements of destination register.

Vector register file has three read ports to read three source vectors in parallel and substantially at the same time. The output of two source vectors that are read from ports VRs-1 110 and from port VRs-2 120 are connected to select logic 150 and 160, respectively. These select logic map two source vectors such that any element of two source vectors could be paired with any element of said two source vectors for vector operations and vector comparison unit inputs 170. The mapping is controlled by a third source vector VRc 130. For example, for vector element position #4 we could pair element #0 of source vector #1 that is read from the vector register file with element #15 of source vector #2 that is read from VRs-2 port of the vector register file. As a second example, we could pair element #0 of source vector #1 with element #2 of source vector #1. The output of these select logic represents paired vector elements, which are connected to SOURCE_{—}1 196 and SOURCE_{—}2 197 inputs of vector operation unit 180 for dyadic vector operations.

The output of vector accumulator is conditionally stored back to the vector register files in accordance with a vector mask from the vector control register elements VRc 130 and vector condition flags from the vector condition flag register VCF 171. The enable logic of 195 controls writing of output to the vector register file.

Vector opcode 105 for SIMD has 32 bits that is comprised of 6-bit opcode, 5-bit fields to select for each of the three source vectors, source-1, source-2, and source-3, 5-bit field to select one of the 32-vector registers as a destination, condition code field, and format field. Each SIMD instruction is conditional, and can select one of the 16 possible condition flags for each vector element position of VCF 171 based on condition field of the opcode 105.

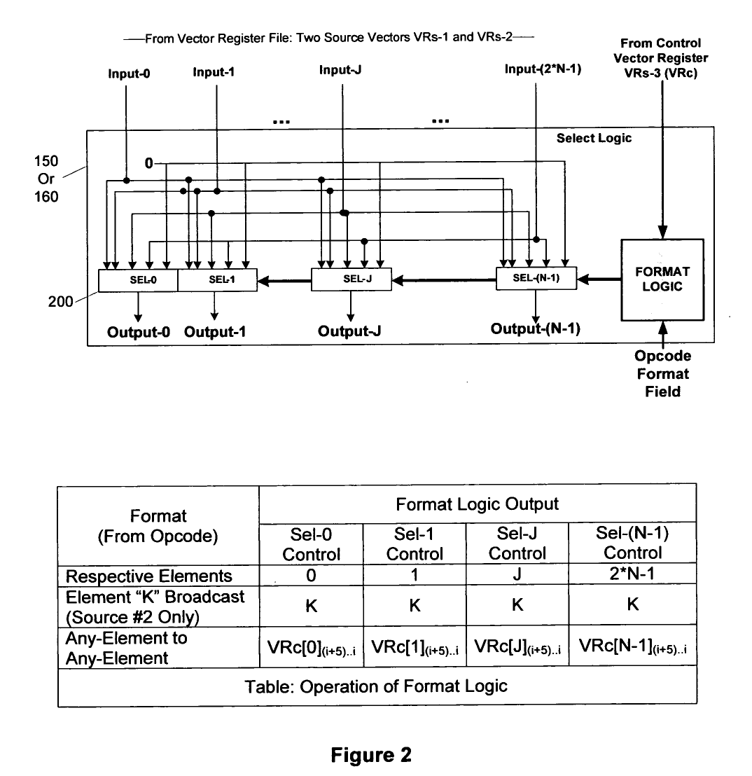

The details of the select logic 150 or 160 is shown in FIG. 2. Each select logic for a given vector element could select any one of the input source vector elements or a value of zero. Thus, select logic units 150 and 160 constitute means for selecting and pairing any element of first and second input vector register with any element of first and second input vector register as inputs to operators for each vector element position in dependence on control register values for respective vector elements.

The select logic comprises of N select circuits, where N represents the number of elements of a vector for N-wide SIMD. Each of the select circuit 200 could select any one of the elements of two source vector elements or a zero. Zero selection is determined by a zero bit for each corresponding element from the control vector register. The format logic chooses one of the three possible instruction formats: element-to-element mode (prior art mode) that pairs respective elements of two source vectors for vector operations, Element “K” broadcast mode (prior art mode), and any-element-to-any-element mode including intra elements (meanings both paired elements could be selected from the same source vector).

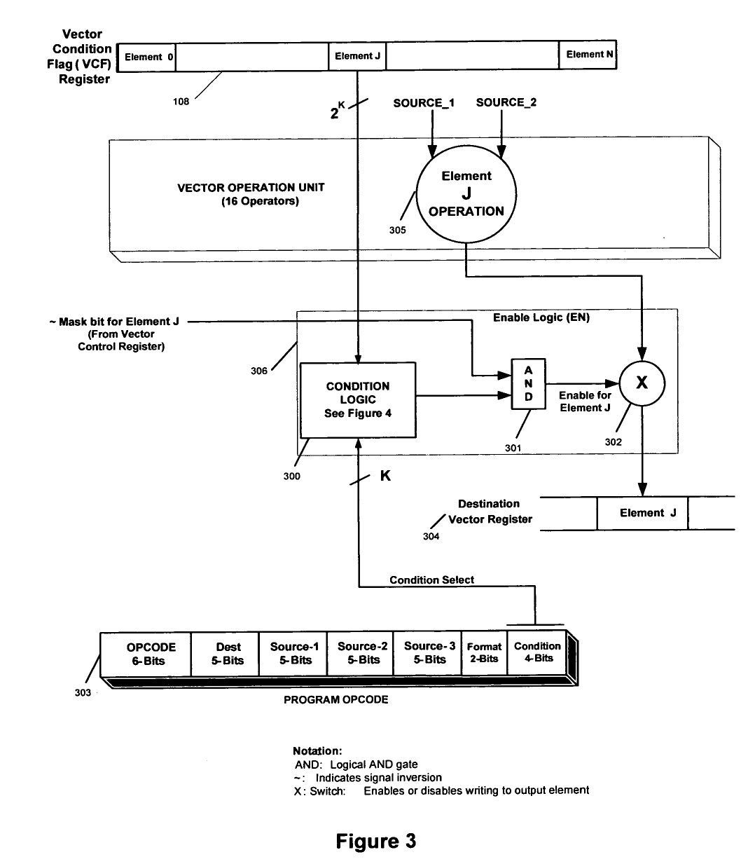

FIG. 3 shows the operation of conditional operation based on condition flags in VCF from a prior instruction sequence and mask bit from vector control register. The enable logic of 306 comprises Condition Logic 300 to select one of the 16 condition flags for each vector element position of VCF, AND logic 301 to combine condition logic output and mask, and as a result to enable or disable writing of vector operation unit into destination vector register 304 of vector register file.

In one preferred embodiment, each vector element is 16-bits and there are 16 elements in each vector. The control bit fields of control vector register is defined as follows:
Bits 4-0: Select source element from S2 ∥ S-1 elements concatenated;
Bits 9-5: Select source element from S1 ∥ S-2 elements concatenated;
Bit 10: 1→ Negate sign of mapped source #2; 0→ No change.
Bit 11: 1→ Negate sign of accumulator input; 0-→ No change.
Bit 12: Shift Down mapped Source_1 before operation by one bit.
Bit 13: Shift Down mapped Source_2 before operation by one bit.
Bit 14: Select Source_2 as zero.
Bit 15: Mask bit, when set to a value of one, it disables writing output for that element.

| Bits 4-0 | Element Selection |
|---|---|
| 0 | VRs-1[0] |
| 1 | VRs-1[1] |
| 2 | VRs-1[2] |
| 3 | VRs-1[3] |
| 4 | VRs-1[4] |
| . . . | . . . |
| 15 | VRs-1[15] |
| 16 | VRs-2[0] |
| 17 | VRs-2[1] |
| 18 | VRs-2[2] |
| 19 | VRs-2[3] |
| . . . | . . . |
| 31 | VRs-2[15] |

| Bits 9-5 | Element Selection |
|---|---|
| 0 | VRs-2[0] |
| 1 | VRs-2[1] |
| 2 | VRs-2[2] |
| 3 | VRs-2[3] |
| 4 | VRs-2[4] |
| . . . | . . . |
| 15 | VRs-2[15] |
| 16 | VRs-1[0] |
| 17 | VRs-1[1] |
| 18 | VRs-1[2] |
| 19 | VRs-1[3] |
| . . . | . . . |
| 31 | VRs-1[15] |

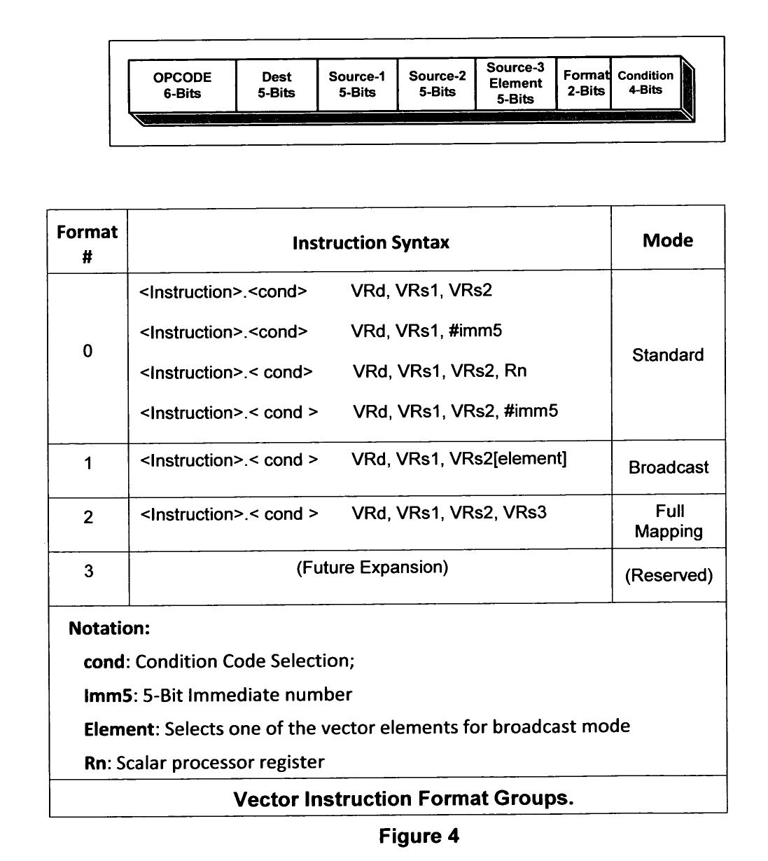

There are three vector processor instruction formats in general as shown in FIG. 4, although this may not apply to every instruction. Format field of opcode selects one of these three SIMD instruction formats. Most frequently used ones are:

| | |
|---|---|
| <Vector Instruction>.<cond> | VRd, VRs-1, VRs-2 |
| <Vector Instruction>.<cond> | VRd, VRs-1, VRs-2 [element] |
| <Vector Instruction>.<cond> | VRd, VRs-1, VRs-2, VRs-3 |

The first form (format=0) uses operations by pairing respective elements of VRs-1 and VRs-2. This form eliminates the overhead to always specify a control vector register. The second form (format=1) with element is the broadcast mode where a selected element of one vector instruction operates across all elements of the second source vector register. The form with VRs-3 is the general vector mapping mode form, where any two elements of two source vector registers could be paired. The word “mapping” in mathematics means “A rule of correspondence established between sets that associates each element of a set with an element in the same or another set”. The word mapping herein is used to mean establishing an association between a said vector element position and a source vector element and routing the associated source vector element to said vector element position.

The present invention provides signed negation of second source vector after mapping operation on a vector element-by-element basis in accordance with vector control register. This method uses existing hardware, because each vector position already contains a general processing element that performs arithmetic and logical operations. The advantage of this is in implementing mixed operations where certain elements are added and others are multiplied, for example, as in a fast DCT implementation.

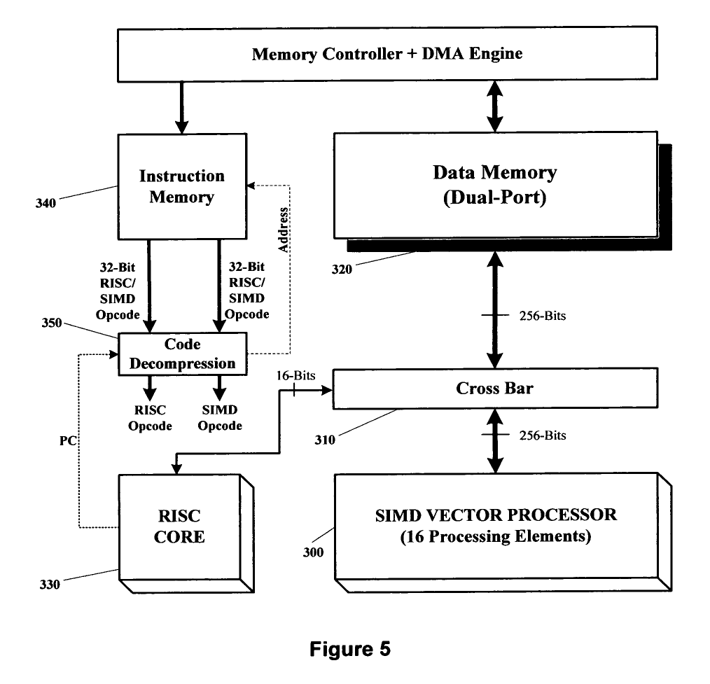

RISC processor is used together with the SIMD processor as a dual-issue processor, as shown in FIG. 5. The function of this RISC processor is the load and store of vector registers for SIMD processor, basic address-arithmetic and program flow control. The overall architecture could be considered a combination of Long Instruction Word (LIW) and Single Instruction Multiple Data Stream (SIMD). This is because it issues two instructions every clock cycle, one RISC instruction and one SIMD instruction. SIMD processor can have any number of processing elements. RISC instruction is scalar working on a 16-bit or 32-bit data unit, and SIMD processor is a vector unit working on 16 16-bit data units in parallel.

The data memory in this preferred embodiment is 256-bits wide to support 16 wide SIMD operations. The scalar RISC and the vector unit share the data memory. A cross bar is used to handle memory alignment transparent to the software, and also to select a portion of memory to access by RISC processor. The data memory is dual-port SRAM that is concurrently accessed by the SIMD processor and DMA engine. The data memory is also used to store constants and history information as well input as input and output video data. This data memory is shared between the RISC and SIMD processor.

While the DMA engine is transferring the processed data block out or bringing in the next 2-D block of video data, the vector processor concurrently processes the other data memory module contents. Successively, small 2-D blocks of video frame such as 64 by 64 pixels are DMA transferred, where these blocks could be overlapping on the input for processes that require neighborhood data such as 2-D convolution.

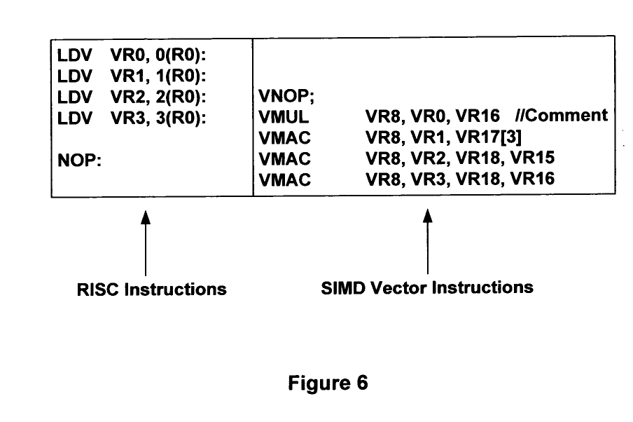

SIMD vector processor simply performs data processing, i.e., it has no program flow control instructions. RISC scalar processor is used for all program flow control. RISC processor also additional instructions to load and store vector registers. Each instruction word is 64 bits wide, and typically contains one scalar and one vector instruction. The scalar instruction is executed by the RISC processor, and vector instruction is executed by the SIMD vector processor. In assembly code, one scalar instruction and one vector instruction are written together on one line, separated by a colon “:”, as shown in FIG. 6. Comments could follow using double forward slashes as in C++. In this example, scalar processor is acting as the I/O processor loading the vector registers, and vector unit is performing vector-multiply (VMUL) and vector-multiply-accumulate (VMAC) operations. These vector operations are performed on 16 input element pairs, where each element is 16-bits.

If a line of assembly code does not contain a scalar and vector instruction pair, the assembler will infer a NOP for the missing instruction. This NOP could be explicitly written or simply omitted.

In general, RISC processor has the simple RISC instruction set plus vector load and store instructions, except multiply instructions. Both RISC and SIMD has register-to-register model, i.e., operate only on data in registers. In the preferred embodiment RISC has the standard 32 16-bit data registers. SIMD vector processor has its own set of vector register, but depends on the RISC processor to load and store these registers between the data memory and vector register file.

Some of the other SIMD processors have multiple modes of operation, where vector registers could be treated as byte, 16-bit, or 32-bit elements. The present invention uses only 16-bit to reduce the number of modes of operation in order to simplify chip design. The other reason is that byte and 32-bit data resolution is not useful for video processing. The only exception is motion estimation, which uses 8-bit pixel values. Even though pixel values are inherently 8-bits, the video processing pipeline has to be 16-bits of resolution, because of promotion of data resolution during processing. The SIMD of present invention use a 48-bit accumulator for accumulation, because multiplication of two 16-bit numbers produces a 32-bit number, which has to be accumulated for various operations such as FIR filters. Using 16-bits of interim resolution between pipeline stages of video processing, and 48-bit accumulation within a stage produces high quality video results, as opposed to using 12-bits and smaller accumulators.

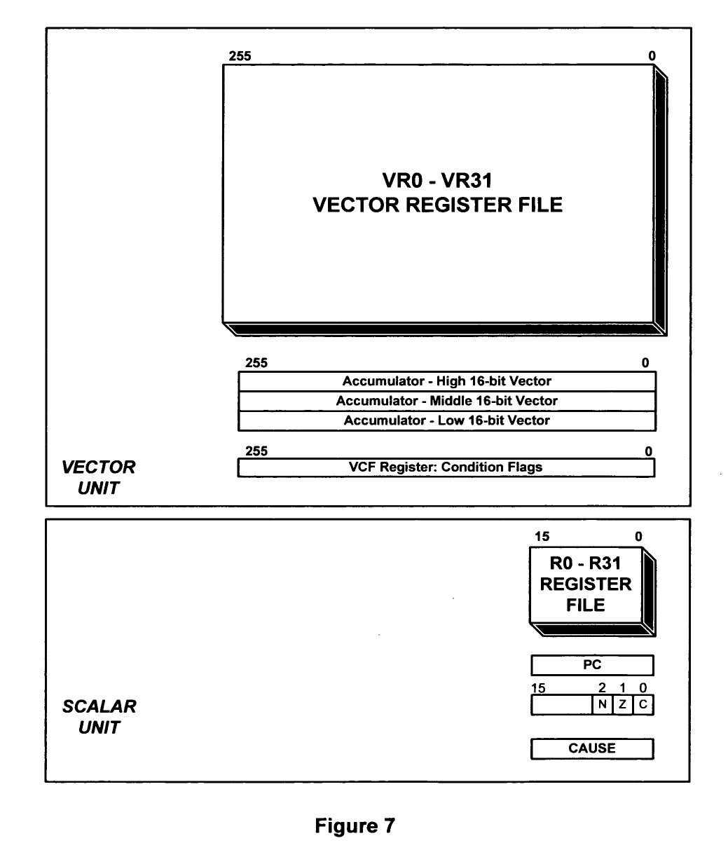

The programmers' model is shown in FIG. 7. All basic RISC programmers' model registers are included, which includes thirty-two 16-bit registers. The vector unit model has 32 vector register, vector accumulator registers and vector condition code register, as the following will describe. The vector registers, VR31-VR0, form the 32 256-bit wide register file as the primary workhorse of data crunching. These registers contain 16 16-bit elements. These registers can be used as source and destination of vector operations. In parallel with vector operations, these registers could be loaded or stored from/to data memory by the scalar unit.

The vector accumulator registers are shown in three parts: high, middle, and low 16-bits for each element. These three portions make up the 48-bit accumulator register corresponding to each element position.

There are sixteen condition code flags for each vector element of vector condition flag (VCF) register. Two of these are permanently wired as true and false. The other 14 condition flags are set by the vector compare instruction (VCMP), or loaded by LDVCR scalar instruction, and stored by STVCR scalar instruction. All vector instructions are conditional in nature and use these flags.

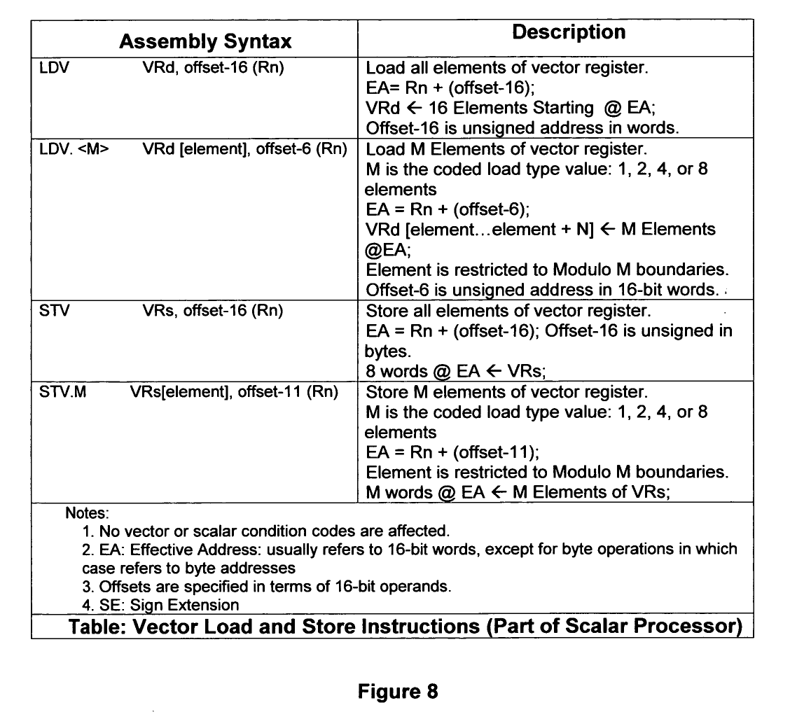

FIG. 8 shows an example of the vector load and store instructions that are part of the scalar processor in the preferred embodiment, but also could be performed by the SIMD processor in a different embodiment. Performing these by the scalar processor provides the ability to load and store vector operations in parallel with vector data processing operations, and thus increases performance by essentially “hiding” the vector input/output behind the vector operations. Vector load and store can load the all the elements of a vector register, or perform only partial loads such as loading of 1, 2, 4, or 8 elements starting with a given element number (LDV.M and STV.M instructions).

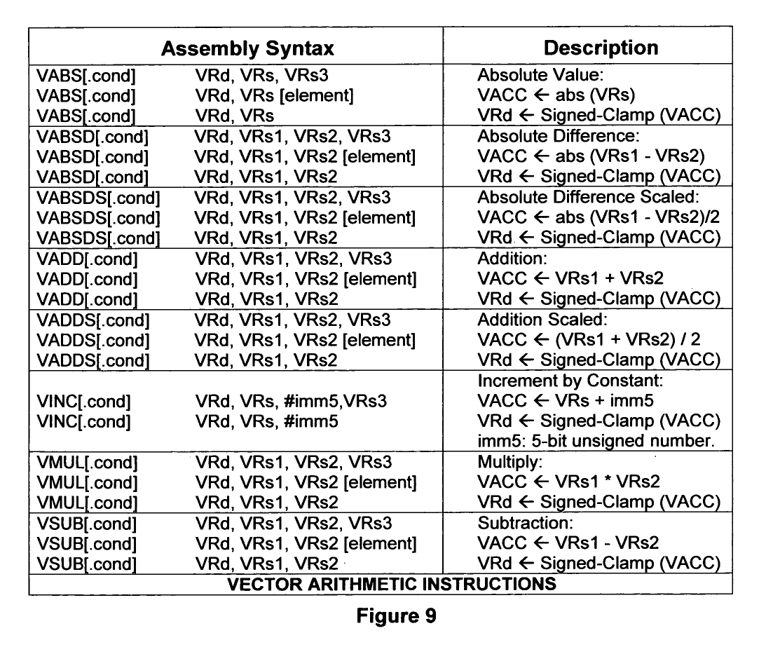

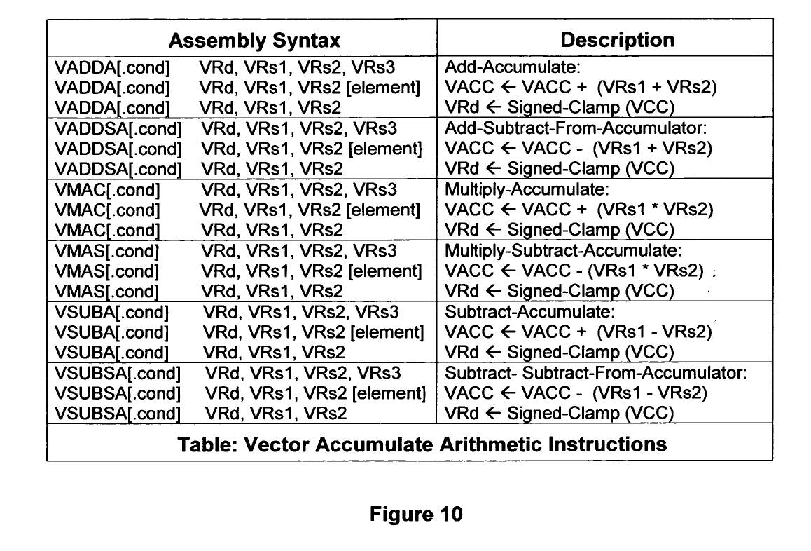

FIG. 9 shows an example of the vector arithmetic instructions. All arithmetic instructions results are stored into vector accumulator. If the mask bit is set, or if the condition flag chosen for a given vector element position is not true, then vector accumulator is not clamped and written into selected vector destination register. FIG. 10 shows an example list of vector accumulator instructions.

The opcode for both scalar and vector unit is 64-bits wide, which consists of 32-bits opcode for scalar processor and 32-bit opcode for vector/SIMD processor. The opcodes are fetched as 64-bits from instruction memory. If either scalar or vector portion is not used for a given instruction, then that portion is set to no-operation, NOP or VNOP, by the assembler, or multiple opcodes of the same type are compacted into a single 64-bit, but executed sequentially. The following lists the possibilities of instruction grouping:
A. Vector Instruction+Scalar Instruction;
B. Vector Instruction+NOP (Scalar NOP);
C. Scalar Instruction+VNOP (Vector NOP);
D. Scalar Instruction+Scalar Instruction;
E. Vector Instruction+Vector Instruction

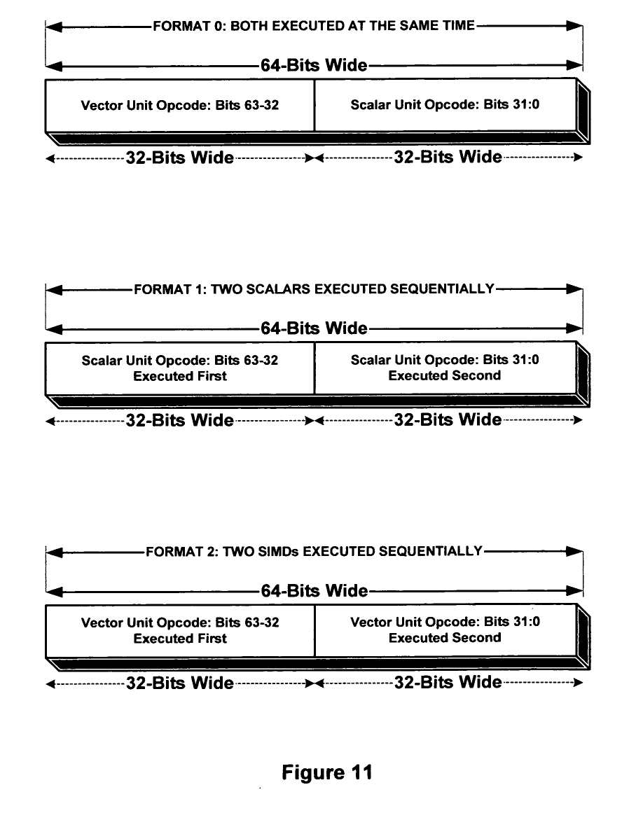

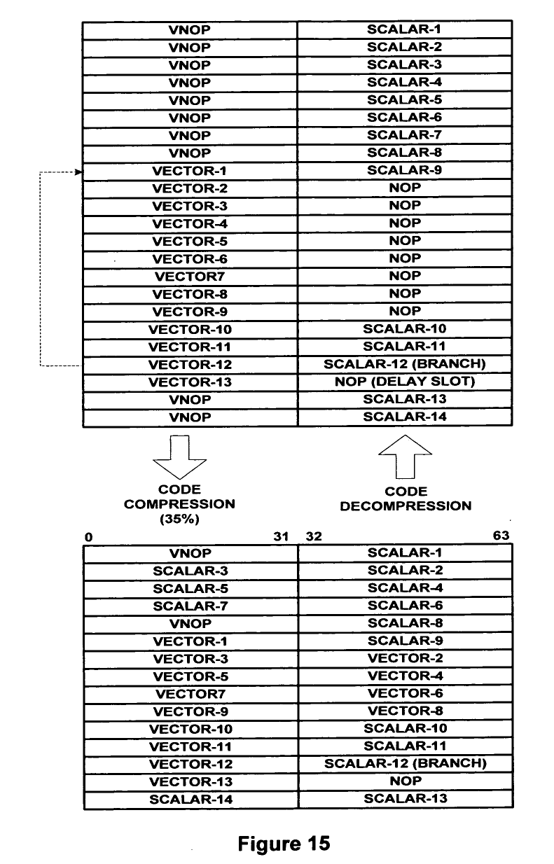

The default after power-up or reset operation is Vector+Scalar instruction or replacement of missing instruction with a corresponding NOP/VNOP, i.e., A, B, or C from above. In order not to waste instruction memory for cases of missing vector or scalar instruction, NOP/VNOP instructions specifies the map of next 13 instruction pairs. This opcode memory compaction is done by the assembler or as a post process to compact program code. An example of this code compaction is shown in FIG. 15. Code decompression unit 350 (see FIG. 5) coupled between the instruction memory and scalar and vector processors performs the opposite of the code compaction, and restores original code with only A-C options from above by substituting two instructions of B or C for each E and D, respectively. This typically achieves about 30-40 percent code compression. The possible combinations of high-level opcode formats are shown in FIG. 11.

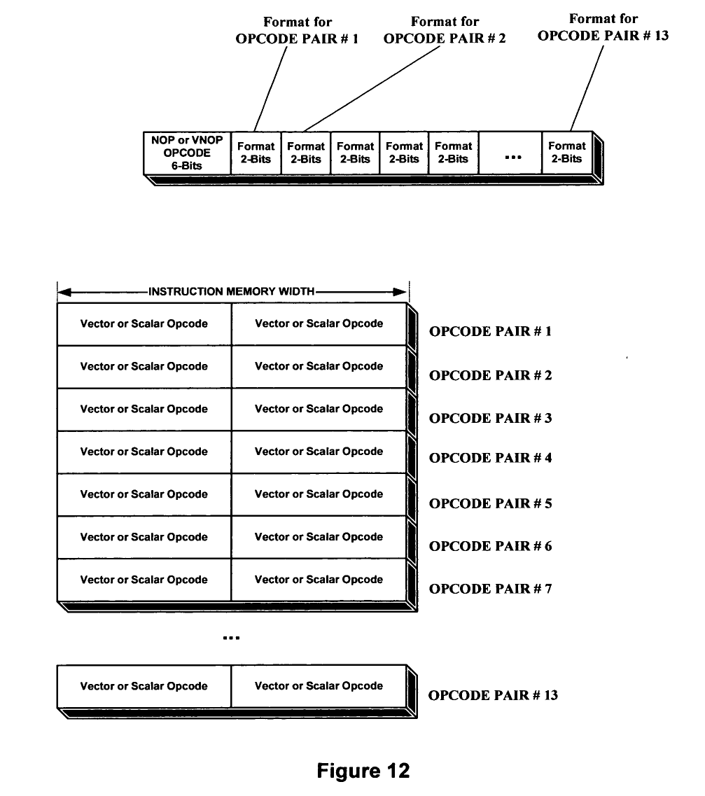

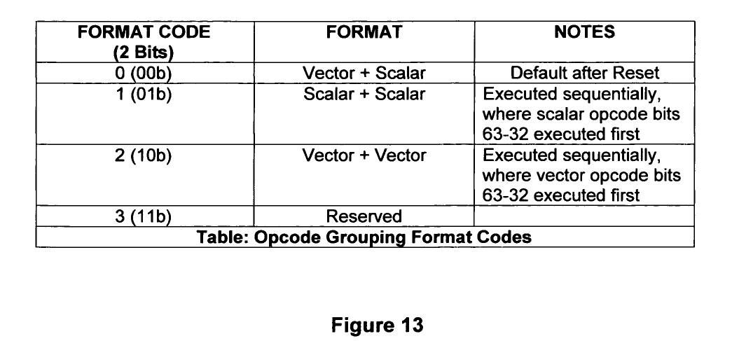

FIG. 12 shows the NOP/VNOP instructions and how it maps the format of instruction pairing. FIG. 13 defines the format fields for the NOP and VNOP instructions. Either instruction can set the instruction pairing for the next 13 instructions pairs following the current instruction pair. The instruction pairing information could be reset by a program flow change or by another NOP or VNOP instruction. Format #0 is the default vector+scalar mode, and thus a NOP or VNOP, both of which all zeros for format #0 case, resets the pipeline to vector plus scalar pairing until another NOP or VNOP, which specifies alternate instruction pairing is encountered.

The following are the restrictions required in instruction pairing to simplify the design:
A. After power up or chip reset, the expected format is Vector plus Scalar;
B. Any program flow change has to jump to a 64-bit aligned address, and the format of instruction at that address is Vector plus Scalar.

### SIMD Opcode Map

The opcode map for SIMD processor remains the same regardless of number of processing elements. For example, if the SIMD processor has 8 or 64 processing elements, the SIMD opcode map remains unchanged. The fact that there is only one opcode for all SIMD operations and that it is independent of number of processing elements makes the tool chain easier to develop and maintain.

### Details of SIMD Vector/Array Processor Opcode Mapping

The opcode consists of the following fields:
Opcode
   This is a 6-bit field that selects of the SIMD operations. This limits the maximum number of SIMD instructions to 64.
Dest
   Specifies the destination vector register, which is part of the primary vector register file. This field selects one of the 32 vector registers. Not all instructions may require a destination vector register, in which case this field may be used for other purposes.
Source-1
   This 5-bit field selects one of the 32 vector registers from vector register file as one of the source operands to a SIMD operation.
Source-2
   This 5-bit field selects the second source operand for dual operand operations. It is allowed to have both source-1 and source-2 operands to be the same. This is useful for vector or array operations within a vector or array, for example, comparing different elements of a vector or array.
Source-3
   This 5-bit field specifies one of the vector registers from the vector register file as the third source operand. Typically, the third source operand is used as a control vector for mapping of vector elements and other control of SIMD operations.
Format
   This two-bit field determines the mode of vector operation, as shown on FIG. 4.
Condition Bits
   All SIMD instructions are conditional. This 4-bit field determines what condition is to be used for a given instruction.

1. (canceled)

2. A dual-issue execution unit for use in a computer system for efficient utilization of program memory, the dual-issue execution unit comprising:
a scalar processor for executing a first instruction opcode;
a vector processor for executing a second instruction opcode, said vector processor comprising:
a register file for containing vector registers, wherein each vector register holds a plurality of vector elements of a predetermined size; and
a vector computational unit for performing a plurality of arithmetic/logical operations in parallel;
a local data memory which is shared by said scalar processor and said vector processor, wherein said scalar processor performs data transfers between said local data memory and said register file;
an instruction memory for providing at least two instruction opcodes per each entry, said scalar processor providing a program counter address to access said instruction memory and managing program flow for both said vector processor and said scalar processor;
an instruction decompression unit with input coupled to said instruction memory fetches a pair of instructions from said instruction memory and determines the pairing of instructions for execution for the following n entries of program memory in accordance with designated fields of a scalar no-operation instruction or a vector no-operation instruction, output of said instruction decompression unit is coupled to said vector processor and said scalar processor, and provides a pair of instructions for execution every clock cycle,
wherein a scalar no-operation instruction maps the next n instruction pairs as one of scalar-plus-vector for parallel execution, scalar-and scalar for sequential execution, and vector-and-vector for sequential execution;
wherein a vector no-operation instruction maps the next n instruction pairs as one of scalar-plus-vector for parallel execution, scalar-and scalar for sequential execution, vector-and-vector for sequential execution; and
Whereby multiple instructions of the same type are compactly stored together when only one scalar or vector instruction needs to be executed, and the size of said instruction memory is reduced.

3. The dual-issue execution unit of claim 2, wherein each no-operation instruction includes a plurality of fields defining the pairing of instructions for the following n entries of program memory, each of said plurality of fields defining one of combinations of scalar-plus-vector, scalar-plus-scalar, and vector-plus-vector opcode pairing for entries, wherein for entries defined as scalar-1-plus-scalar-2 and vector-1-plus-vector-2, said instruction decompression unit sequences output of two instructions as scalar-1-and-vector-nop, followed by scalar-2-and-vector-nop, and scalar-nop-and-vector-1, followed by scalar-no-and-vector-2, respectively, for execution by said scalar and vector processors in parallel.

4. The dual-issue execution unit of claim 2, wherein a program flow control change instructions resets the said instruction decompression unit to interpret the next instruction pair as scalar-plus-vector, until another no-operation instruction with mapping information is encountered.

5. The dual-issue execution unit of claim 2, wherein each no-operation instruction includes a map of instruction pairing for the next 13 entries of said instruction memory.

6. A execution unit for use in a computer system for reducing size of program memory, the execution unit comprising:
a RISC processor for executing a RISC instruction opcode;
a vector processor for executing a vector instruction opcode,
an instruction memory for providing two instruction opcodes to an instruction decompression unit, said RISC processor managing program flow for both said vector processor and said RISC processor;
said instruction decompression unit functions to fetch a pair of instructions from said instruction memory in parallel and determines the pairing of instructions for execution for the following n entries of program memory, when a no-operation instruction is detected, in accordance with designated fields of a scalar no-operation instruction or a vector no-operation instruction; and
said instruction decompression unit is coupled to said vector processor and said RISC processor, and provides a pair of instructions for execution every clock cycle.

7. The execution unit of claim 6, wherein said instruction decompression unit saves the instruction pairing map for the next n entries of said instruction memory when a scalar or a vector no-operation is detected, and sequences address of said instruction memory accordingly for executing an entry in one clock cycle as pair of scalar-plus-vector opcode, or in two clock cycles as a sequence of two instructions of the same type.

8. The execution unit of claim 6, wherein said instruction decompression unit returns to default state of scalar-plus-vector interpretation of said instruction memory at start up, after a program flow change, or when no no-operation instruction is encountered for n entries.

9. The execution unit of claim 6, wherein said instruction decompression unit provides scalar-plus-vector instruction pair for parallel execution by providing scalar opcode to said RISC processor, and vector opcode to said vector processor, scalar-1-plus-scalar-2 instruction pair are provided to said RISC processor in a sequence of two clock cycles along with insertion of vector no-op for said vector processor, and vector-1-plus-scalar-2 instruction pair are provided to said vector processor in a sequence of two clock cycles along with insertion of scalar no-operation opcode.

10. The execution unit of claim 6, wherein a compiler inserts one scalar or vector no-operation instruction every n entries of combined program code to convey mapping information the said instruction decompression unit so that no program memory is wasted.

11. The execution unit of claim 6, wherein said scalar and vector instruction words are 32-bits, each, and uses an opcode field of 6 bits, which provides n of 13 2-bit fields defining instruction pairing for following instructions.

12. A method for operating a vector processor having a plurality of arithmetic units and a vector register file coupled to a scalar processor, the method comprising:
a) providing an instruction memory, wherein said scalar processor provides a program control address for fetching two instructions from an entry of said instruction memory concurrently;
b) interpreting said fetched instructions as a scalar instruction word and a vector instruction word as a default state, providing said scalar instruction word to said scalar processor and said vector instruction word to said vector processor for execution;
c) detecting a scalar or vector no-operation instruction word, and capturing n bit-fields following the opcode of said scalar no-operation word, or said vector no-operation word;
d) decoding said n bit-fields to map the next n entries of said instruction memory as one of the following combinations: scalar-plus-vector instruction words, scalar-plus-scalar instruction words, and vector-plus-vector instruction words, and saving it in a local storage;
e) fetching next instruction pair from said instruction memory and interpreting it in accordance with first entry of said n bit-field and performing one of the following steps accordingly:
providing said scalar-plus-vector instruction words for parallel execution to respective scalar and vector processors;
providing said vector-plus-vector instruction words for execution sequentially to vector processors in two clock cycles, and providing a scalar no-operation opcode in parallel to said scalar processor;
providing said scalar-plus-scalar instruction words for execution sequentially to scalar processor in two clock cycles, and also providing a vector no-operation opcode in parallel to said vector processor;
f) repeating step e until all said n bit-fields are exhausted, or a program flow instruction is encountered, or another no-operation instruction with new said n-field information is detected, and then said instruction decompression unit goes back the default state and interpreting said fetched instructions as a scalar instruction word and a vector instruction word until next no-operation instruction word.

13. The method of claim 12, wherein n equals at least 13.

14. The method of claim 12, wherein a compiler inserts one vector or scalar no-operation every n entries of said instruction memory so as to ensure continuous and uninterrupted mapping of instruction pairs.

15. The method of claim 12, wherein a compiler ensures that default state of scalar-plus-vector pairing is stored at destination of branch or program jump addresses of said instruction memory.
